(19) United States
(12) Patent Application Publication
(10) Pub. No.: US 2017/0036385 A1
(43) Pub. Date: Feb. 9, 2017

(54) APPARATUS AND METHOD FOR FORMATION OF SEPARATOR AND CASING FOR MULTI CONDUCTOR WIRE IN A SINGLE OPERATION

(71) Applicants: James Anthony Suleski, Cherry Hill, NJ (US); William Moore, Maple Shade, NJ (US)

(72) Inventors: James Anthony Suleski, Cherry Hill, NJ (US); William Moore, Maple Shade, NJ (US)

(21) Appl. No.: 15/228,087

(22) Filed: Aug. 4, 2016

Related U.S. Application Data
(60) Provisional application No. 62/200,834, filed on Aug. 4, 2015.

(51) Int. Cl. B29C 47/20; B29C 47/02; B29C 47/00

(52) U.S. Cl. CPC B29C 47/20; B29C 47/0016; B29C 47/025; B29L 2031/3462

(57) ABSTRACT

An apparatus and manufacture process for forming a separator between multiple electrical conductors and forming exterior casing are made in one manufacture operation. This new process and tip eliminate the possibility of a conductor or pair to jump over to another conductor or pair to cause cross-talk. The tip and process provide more consistent spacing of multiple internal conductor wires within a cable jacket.

### CROSS-REFERENCE TO RELATED APPLICATION

This application claims the benefit of priority of U.S. provisional application No. 62/200,834, filed Aug. 4, 2015, the contents of which are herein incorporated by reference.

### BACKGROUND OF THE INVENTION

The present invention relates to systems and processes for applying a protective jacket to electrical conductors, such as wires and, more particularly, to the application of protective jackets to wiring containing multiple conductors. Present processes and tip for manufacturing multiple conductor electrical wiring, such as twisted pair wiring utilized for communications wires, require a number of steps that introduce opportunities for producing defective batches of finished wire, or finished wire that suffer from degraded quality issues.

In a conventional process for producing a multi-conductor cable, such as the aforementioned twisted pair communications wire, the first step is to provide a source of twisted pair wire. The source may be a commercially purchased spool of twisted pair wire, where each conductor in the twisted pair is provided with a protective coating, such as an insulator, to prevent electrical communication between the wires in the twisted pair. Alternatively, the manufacture will implement a process for forming the conductors in the twisted pair are extruded with a protective jacket. The primaries are then twisted at a specified number of twists per linear inch, as defined by standards applicable to the desired end use of the product. Next, a primary separator filler is extruded utilizing conventional extrusion techniques. With conventional processes, the fourth step requires that the primaries and separator material are “spooled up” for the fifth step in the conventional process. This step includes aligning various spool with the extruder and keeping the strands in the spools from entanglement during an extrusion process with suspended separator arms so that the primaries and the spooled separator materials don't become entangled when the primaries are fed into the extruder. In the fifth step, the spooled separator material and primaries are extruded together with an outer jacket or protective casing.

According to current practices, potential for error exists in the improper laying of the primaries in the separator material, which permits a primary to jump over to a neighboring primary. This causes an undesirable condition in the finished product, referred to as cross-talk. This condition is only detected after the product is finished. When detected by the manufacturer, the defective finished material may be cut and sold in smaller batches, or recycled for scrap. When detected after installation of the finished wire in a communications infrastructure, the customers in the value chain are greatly dissatisfied. In either case, the production of defective wiring according to present methods is wasteful.

The multiple manufacture operations in conventional processes thus increase the cost of manufacture and a higher level of product defects. Moreover, the larger the number of manufacturing processes to make the cable, the harder to maintain a consistent quality level and consistent spacing of multiple internal primaries within a cable jacket, particularly for large runs of cable.

As can be seen, there is a need for improved tip and processes for the manufacture of multi-stranded conductor cables.

### SUMMARY OF THE INVENTION

One aspect of the present invention includes a process for manufacturing a multi-conductor cable having a separator between adjacent conductors. The process includes mounting an extrusion tip in an extrusion apparatus, the extrusion tip having an elongate body with a shaped channel extending through an interior portion of the elongate body. A plurality of bores extend through a longitudinal axis of the extrusion tip, wherein the shaped channel has at least one lobe separating each bore from an adjacent bore. A primary conductor is through the plurality of bores. A source of an extrusion material is applied to a port defined through an outer surface of the elongate body and in fluid communication with the at least one lobe, the extrusion material forming a separator within the shaped channel. The process may further include applying an extrusion material to a jacket channel surrounding an outer surface of the extrusion tip, the extrusion material forming a protective jacket around the conductors of the multi conductor cable.

In preferred embodiments, the process includes extruding the multi-conductor cable such that ends of the separator lobe form with the protective jacket. It may further include extruding the multi-conductor cable to form a lumen between the separator and the protective jacket. The plurality of primaries are carried on a spool to feed the extrusion tip. Each of the primary conductor are drawn carried within a separate lumen. The primary conductor may include a plurality of conductors, more preferably a twisted pair.

Other aspects of the invention include an extrusion tip having an elongate body with a plurality of bores extending longitudinally between a front face and a back face of the extrusion tip. The bores are dimensioned to receive a conductor through the bore. A shaped channel is defined within a portion of the elongate body, the shaped channel having at least one lobe interposed between adjacent bores. An aperture is defined in an outer surface of the elongate body and in fluid communication with the shaped channel. Preferably, the aperture is forwardly inclined to fluidly connect the aperture with the at least one lobe of the shaped channel. The opening of the bores may have a chamfered end.

These and other features, aspects and advantages of the present invention will become better understood with reference to the following drawings, description and claims.

### BRIEF DESCRIPTION OF THE DRAWINGS

FIG. 1 is a rear perspective view of an embodiment of an extruder tip of the invention, shown in use;

FIG. 2 is a rear perspective view of the extruder tip;

FIG. 3 is a front perspective view of the extruder tip;

FIG. 4 is a rear perspective view of the extruder, showing bores 14 and ports 16;

FIG. 5 is a rear perspective view of the invention, showing material entry ports 16 and conductor bores 14;

FIG. 6 is a section view of the invention, taken along line 6-6 in FIG. 2;

FIG. 7 is a section view of the invention, taken along line 7-7 in FIG. 2;

FIG. 8 is a front view of the front view of the invention; and

FIG. 9 is a section view of an embodiment of a multi-conductor wire formed with tip 10.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tip and a process for the application of a separator 26 between conductors 22, or pairs of conductors, in a multi-conductor cable 28 and to apply a protective outer casing 24 to the separated conductors 22 to form the multi-conductor conductor cable 28 in a single manufacture operation.

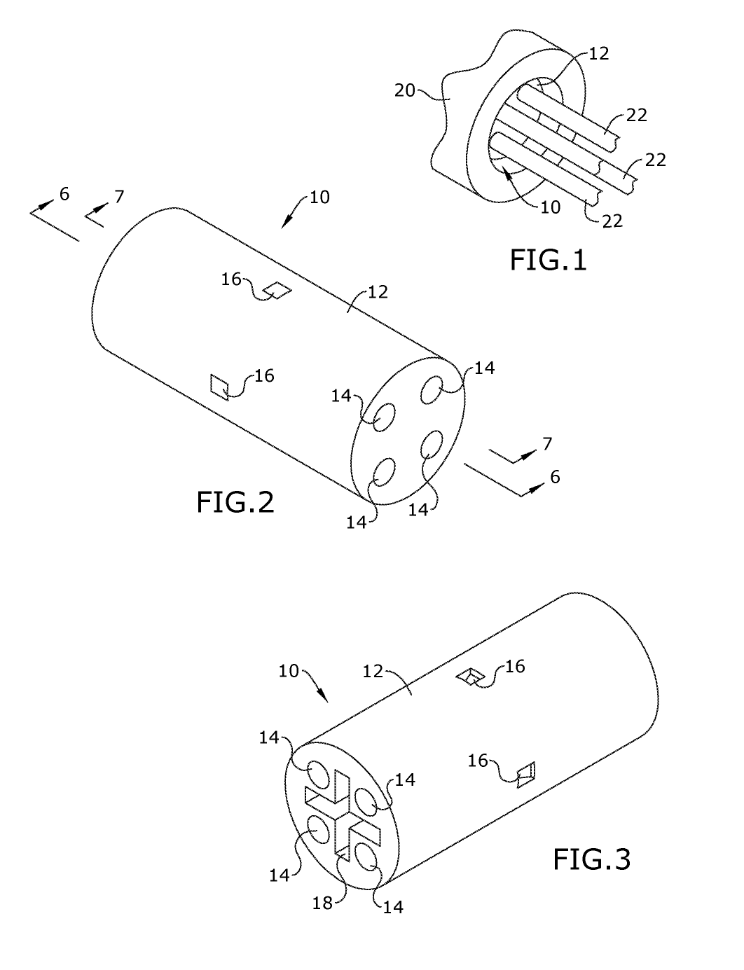

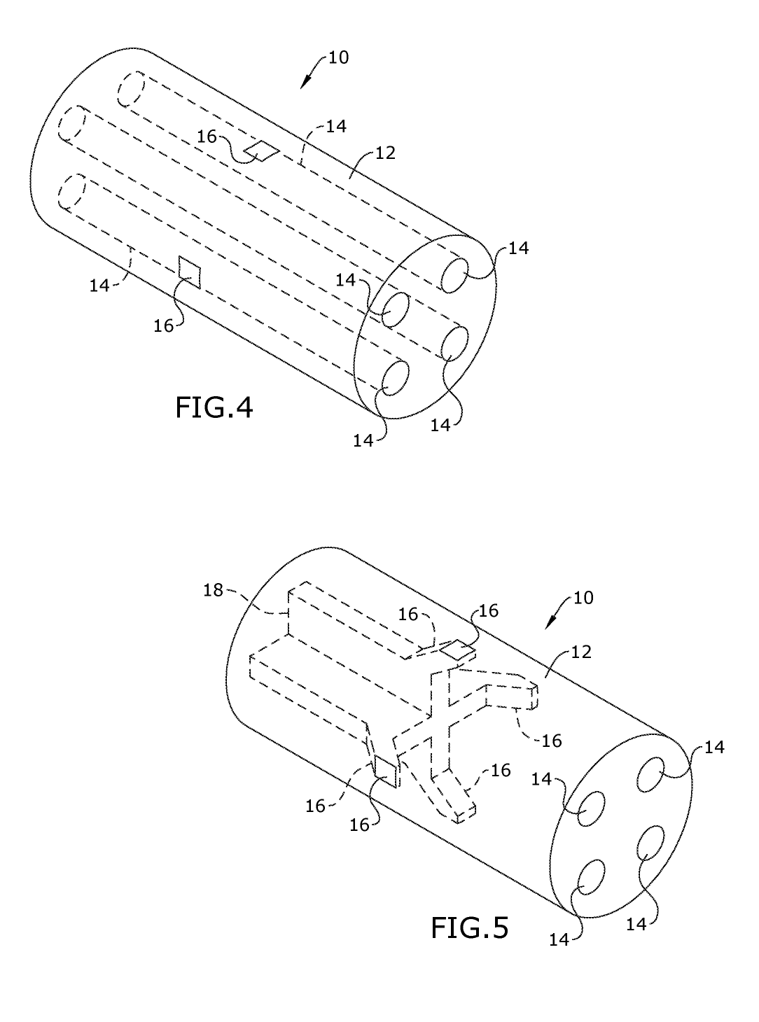

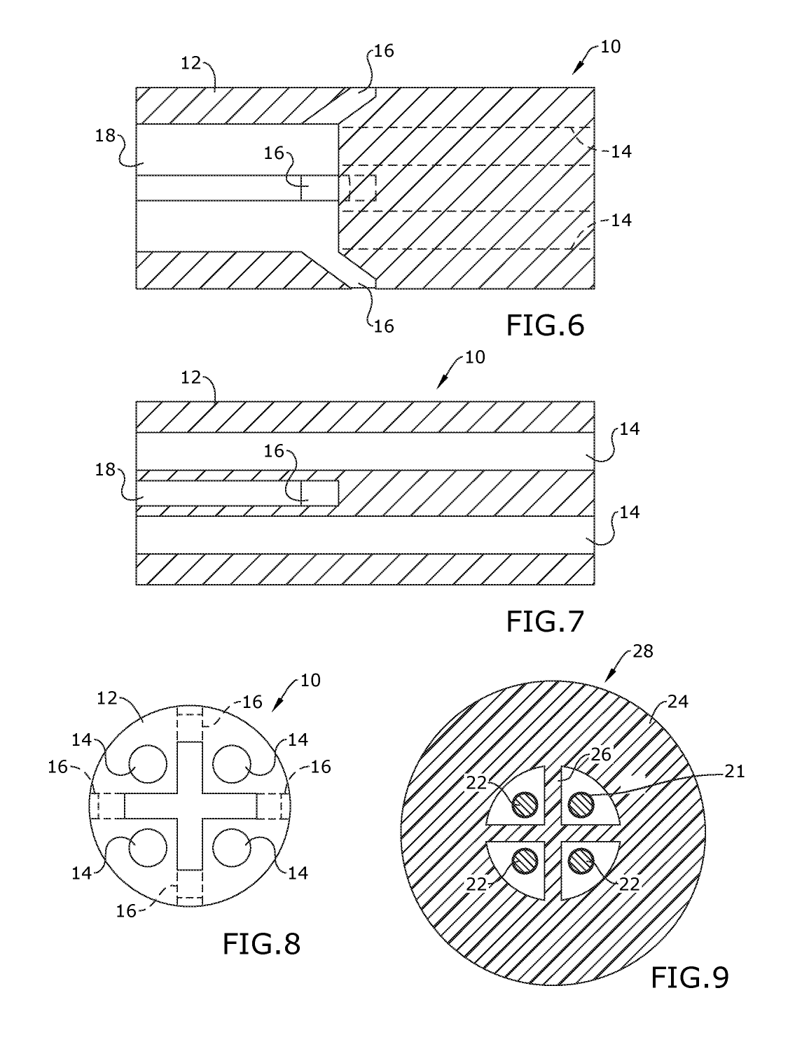

Referring now to FIGS. 1 through 9, according to a preferred embodiment of the invention, there is shown an embodiment of an extrusion tip 10 of the present invention and an embodiment of a multi-conductor cable formed 28 according to the invention. The tip 10 is used in an extrusion process for applying a separator 26 between a plurality of conductors 22 and applying an outer protective casing 24 to the multi-conductor cable 28 in a single operation. The conductors 22, may be a single conductor wire, or the conductors 22 may have a plurality of wires, such as a twisted pair of wires carried therein with a protective sheath 21.

As best seen in reference to FIG. 1, in a preferred embodiment of a tip 10 according to the present invention, the tip 10 is formed of a substantially solid elongate body having a plurality of bores 14 extending between a front end of the tip 10 to a back end of the tip 10. In the representative embodiment shown, there are four bores 14, defined in a spaced apart relation, beginning on a rear face of the tip 10. According to the present invention the number of bores 14 may vary from the depicted four bores, such that a bore is provided for each conductor 22, or primary wires (a.k.a. primaries), that will be encased in a protective jacket 24 within the multi-conductor cable 28 produced by the tip 10.

For ease of manufacture of the tip 10, the bores 14 may be drilled such that they are substantially parallel along the longitudinal length of the substantially solid elongate body 12. The bores 14 exit the body at a front end surface of the tip 10. As will be further described below, the bores 14 have a diameter corresponding a diameter of the conductors 22 that are fed through the bores 14. The openings to the bores on the rear face of the tip may have a chamfered or rounded edge between the rear face and the inner surface of the bores 14 so as to prevent damaging the conductor 22 or protective jacket for the conductor that may be fed into the tip 10 through the openings 14.

As may best be seen in reference to FIGS. 1, 4 and 5, a shaped channel 18 is defined through at least a portion of the elongate body 12 beginning at the front face of the elongate body 12 and extending inwardly along a longitudinal axis of the elongate body 12. The shaped channel 18 has at least one lobe. In the embodiment shown in the drawings, the shaped channel 18 within the elongate body 12 has four lobes, wherein each lobe 18 is positioned between adjacent bores 14. As will be further described below, the shaped channel 18 is adapted to receive and inject an extrusion material to define a separator 24 between adjacent conductors 22 so as to provide a separation between adjacent conductors 22 within the resultant multi-conductor cable 28.

A plurality of apertures 16 are defined through an outer surface of the elongate body 12. The apertures 16 define a port through the elongate body 12 to intersect with and open in fluid communication into each lobe 18. The apertures 16 and ports are adapted to receive an extrusion material there through to define the splitter 26 during the extrusion process defined below. As best seen in reference to FIG. 5, the ports 16 are preferably angled towards the front face of the body 12 to facilitate the flow of an extrusion material through the apertures 16 and into the lobes 18. During the extrusion process, the extrusion material forms a separator 26 between the conductors 22 as the extrusion material traverses through the channel 18 and exits from the front of the tip 10. More preferably, the extrusion material at the periphery of the lobes 18 will join and form with an outer protective casing 24 to the multi-strand cable 28. In a preferred embodiment, the thickness of the separator 26 will be on the order of about 20% of the thickness of the outer protective casing 24.

Having thus described a representative tip according to the present invention, the following description addresses the use of the tip in a representative process for applying a separator 26 between a plurality of conductors 22 in a multi-conductor cable 28.

According to a process of the present invention, once the primaries 22 are made to the required specifications for the finished product, the tip 10 of the present invention takes over and eliminates the traditional separator manufacturing step. The separator manufacturing step, according to a process of the present invention combines and separates the plurality of primary wires 22 from one another. The separator process is preferably done before the cable jacket manufacturing step. According to another preferred embodiment of the process of the invention the separator 26 and jacket 24 processes are able to be combined in a single one-pass one process. By making the separator 26 and outer casing 24 in a single manufacture operation, the process can utilize the same extrusion material for both the separator 26 formation and formation of the outer casing 24. This benefit of the process assures a higher level of quality control for the raw extrusion material requirements.

By way of example to produce communication cable 28 according to a process of the present invention: four spools of twisted pair primaries 24 are mounted on a payoffs, one for each spool of primaries 24. Then the conductor primaries 22 are routed through the bores 14 from the back face of the tip, which has been mounted on an extruder. The primaries 22 are routed through the bores 14 via a lead line secured to a leading end of each primary 22. Tension is applied to the lead lines to draw the conductor primaries 22 through the bores 14 in the tip 10. As the primaries 22 are drawn through the tip 10, then a source of extrusion material is fed through the extruder and enters the ports 16 in the outer surface of the tip 10. As the extrusion material enters the channel 18, the separator 26 is formed as the extrusion material conforms to and is shaped by the inner surfaces of the lobes in the channel 18 as the extrusion material flows through the channel 18. The protective casing 24 is extruded via a channel defined around the outer surface of the tip 10 and forms with the separator 24 as the cable 28 exits the forward end of the extrusion tip 10. As with conventional extrusion processes, adjustments to the extruder and line speed are made to obtain the desired flow of extrusion material. The process of the present invention thereby produces a multi-conductor cable 28 with the separator 26 formed between the conductors 22 and the application of the outer casing in a single manufacture operation. Each of the primaries 22 are carried within their own lumen 25, defined between the respective lobes of the separator 26 and the outer casing 24. Because the conductors 22 are able to move within the lumen 25, they are better able to relieve tension when the cable 28 is bent or wound, such as around a spool for containment following manufacture, storage, and playout of the cable 28 during installation.

As will be further appreciated the tip and process of the present invention reduces the cost of manufacturing multi-stranded cable by reducing the number of manufacture operations required. Application of the present invention results in a stronger multiple electrical conductor cable that is less likely to fail.

This invention is an improvement on what currently exists in that it reduces cost of manufacture by reducing the number of manufacture operations required. It results in a stronger multiple electrical conductor cable, less likely to fail. Moreover, the formation of the separator according to the present invention eliminates the possibility of a conductor or pair jumping over to another pair to cause undesirable cross-talk and provides more consistent spacing of multiple internal conductors within a cable outer casing.

An additional aspect of the invention and process according to the present is that a multi-lumen tubing material may be created by the same extrusion process and tip, by running the extrusion material through the tip without feeding the primaries through the bores. Such material may be suitable for medical tubing, and similar applications, that require separate internal chambers to communicate dissimilar fluids or to communicate similar and dissimilar fluids in different directions. It should be understood, of course, that the foregoing relates to exemplary embodiments of the invention and that modifications may be made without departing from the spirit and scope of the invention as set forth in the following claims.

What is claimed is:

1. A process for manufacturing a multi-conductor cable having a separator between adjacent conductors, comprising:
mounting an extrusion tip in an extrusion apparatus, the extrusion tip having an elongate body with a shaped channel extending through an interior portion of the elongate body, a plurality of bores extending through a longitudinal axis of the extrusion tip, wherein the shaped channel has at least one lobe separating each bore from an adjacent bore
drawing a primary conductor through the plurality of bores,
applying a source of an extrusion material to a port defined through an outer surface of the elongate body and in fluid communication with the at least one lobe, the extrusion material forming a separator within the shaped channel.

2. The process of claim 1, further comprising:
applying an extrusion material to a jacket channel surrounding an outer surface of the extrusion tip, the extrusion material forming a protective jacket around the conductors of the multi conductor cable.

3. The extrusion process of claim 2, further comprising:
extruding the multi-conductor cable such that ends of the separator lobe form with the protective jacket.

4. The extrusion process of claim 3, further comprising:
extruding the multi-conductor cable to form a lumen between the separator and the protective jacket.

5. The extrusion process of claim 3, wherein the plurality of primaries are carried on a spool to feed the extrusion tip.

6. The extrusion process of claim 4, wherein each of the primary conductor are drawn carried within a separate lumen.

7. The extrusion process of claim 1, wherein the primary conductor comprises a plurality of conductors.

8. The extrusion process of claim 7, wherein the primary conductor is a twisted pair.

9. An extrusion tip comprising:
an elongate body having a plurality of bores extending longitudinally between a front face and a back face of the extrusion tip, the bores dimensioned to receive a conductor through the bore;
a shaped channel defined within a portion of the elongate body, the shaped channel having at least one lobe interposed between adjacent bores;
an aperture defined in an outer surface of the elongate body and in fluid communication with the shaped channel.

10. The extrusion tip of claim 9, wherein the aperture is forwardly inclined to fluidly connect the aperture with the at least one lobe of the shaped channel.

11. The extrusion tip of claim 9, wherein an opening of the bores has a chamfered end.

12. The extrusion tip of claim 9, wherein the bores are spaced apart and substantially parallel along the longitudinal axis of the extrusion tip.
